(19) United States
(12) Patent Application Publication
(10) Pub. No.: US 2026/0034960 A1
(43) Pub. Date: Feb. 5, 2026

(54) SYSTEM AND METHOD FOR IMMOBILIZING A VEHICLE

(71) Applicant: GM Global Technology Operations LLC, Detroit, MI (US)

(72) Inventors: Richard A. Kulas, Dexter, MI (US); Junghyun Kim, South Lyon, MI (US); Helen M. Rieland, Troy, MI (US)

(73) Assignee: GM GLOBAL TECHNOLOGY OPERATIONS LLC, Detroit, MI (US)

(21) Appl. No.: 18/791,609

(22) Filed: Aug. 1, 2024

(51) Int. Cl. B60R 25/06; B60R 25/20

(52) U.S. Cl. CPC B60R 25/06; B60R 25/20

(57) ABSTRACT

A method of immobilizing a vehicle having a powertrain configured to provide vehicle propulsion includes detecting, via an electronic controller, vehicle systems being enabled by a vehicle key. The method also includes detecting the vehicle being operated in standard production mode, wherein a vehicle mode selector is enabled to shift the powertrain between vehicle propulsion and park modes. The method additionally includes detecting execution of a first predefined pattern, via the vehicle mode selector, indicative of a vehicle immobilization mode. The method also includes activating the vehicle immobilization mode in response to the detected enablement of the vehicle systems, operation of the vehicle in standard production mode, and execution of the first predefined pattern via the vehicle mode selector. The vehicle immobilization mode includes being activated to block the vehicle propulsion and the vehicle park mode being maintained regardless of an operator command to the contrary.

### INTRODUCTION

The present disclosure relates to a system and a method for immobilizing a vehicle, such as for showroom display or demonstration.

A modern passenger, recreation, and work vehicle, such as a passenger car, truck, tractor, etc., generally includes a powertrain having one or more powerplants, such as an internal combustion engine and electric or traction motor(s). An electric vehicle, also called an EV, uses one or more traction motors for propulsion. An electric vehicle may be powered through a collector system by electricity from off-vehicle sources, or may be self-contained with a battery, solar panels, or an electric generator to convert fuel to electricity.

A plug-in electric vehicle (PEV) is a motor vehicle that includes a rechargeable battery pack that may be recharged from an external source of electricity, such as a wall socket, while the electricity stored in the rechargeable battery pack drives or contributes to driving the wheels. PEV is a subcategory of electric vehicles that includes all-electric or battery electric vehicles (BEVs), plug-in hybrid vehicles (PHEVs), and electric vehicle conversions of hybrid electric vehicles and internal combustion engine vehicles. A hybrid electric vehicle (HEV) typically combines a fossil fuel-powered engine with some form of electric propulsion.

A motor vehicle powertrain may also include a transmission assembly, such as a single-or multi-speed transmission, and a differential or final drive. A multi-speed automatic transmission increases the overall operating range of the vehicle without requiring an operator of the vehicle to manually select specific speed-ratios or gear ranges in a forward or drive mode. Transmissions generally also provide a reverse mode, permitting the powerplant(s) to move the vehicle in a direction opposite to the drive mode, and a park mode which operates to block vehicle movement.

Operation of modern powertrains is typically managed by specifically programmed electronic controllers. Thus programmed, a controller generally uses data from various vehicle sensors to, for example, deliver fuel and air and time the spark in the internal combustion engine, or supply electrical energy to the electric motor(s). The controller may also be programmed to determine how and when to change gears in an automatic transmission for desired vehicle performance, efficiency, and passenger comfort. Although such a controller is generally programmed to automatically operate the powertrain in drive mode, selection between drive, reverse, and park modes is typically reserved for the vehicle operator.

### SUMMARY

A method of immobilizing a vehicle having a powertrain configured to provide vehicle propulsion includes detecting, via an electronic controller configured to manage operation of vehicle systems, the vehicle systems being enabled by a vehicle key. The method also includes detecting the vehicle being operated in standard production or mobilized mode, wherein a vehicle mode selector is enabled to shift the powertrain between a vehicle propulsion mode and a vehicle park mode. The method additionally includes detecting execution of a first predefined pattern, via the vehicle mode selector, indicative of a vehicle immobilization mode.

The method also includes activating the vehicle immobilization mode in response to the detected enablement of the vehicle systems by the vehicle key, operation of the vehicle in standard production mode, and execution of the first predefined pattern via the vehicle mode selector. The vehicle immobilization mode includes a vehicle park mode being activated to block the vehicle propulsion mode. The vehicle immobilization mode also includes the vehicle park mode being maintained regardless of an operator command to disengage the park mode.

The method may also include triggering, via the electronic controller, a sensory indicator, such as an audible alert and/or a visual display, indicative of the immobilization mode being active.

The method may additionally include storing, via the electronic controller, the immobilization mode in a memory of the electronic controller between powertrain operation cycles and maintaining the immobilization mode following recovery from a loss of electrical power to the electronic controller.

The vehicle park mode may include engagement of a park pawl in an automatic transmission. In such an embodiment, maintaining the vehicle in park mode may include maintaining engagement of the park pawl regardless of a request to disengage the park pawl.

The vehicle park mode may include actuation of a parking brake. In such an embodiment, maintaining the vehicle in park mode may include maintaining actuation of the parking brake regardless of a request to disengage the parking brake.

The method may additionally include detecting, via the electronic controller, the vehicle systems being enabled by the vehicle key, detecting, via the electronic controller, the vehicle being operated in the vehicle immobilization mode, detecting, via the electronic controller, and execution of a second predefined pattern via the vehicle mode selector indicative of deactivation of the vehicle immobilization mode. In such an embodiment, the method may further include commanding, via the electronic controller, deactivation of the vehicle immobilization mode in response to the detected execution of the second predefined pattern indicative of the deactivation of the vehicle immobilization mode.

Each of the first and second predefined patterns executed via the vehicle mode selector may be a distinct sequence of positions of the vehicle mode selector.

Execution of each of the first and second predefined patterns may be accompanied by lack of engagement of vehicle brakes via a vehicle brake actuator, such as a foot brake pedal.

The powertrain may include a traction motor and an energy storage device configured to supply the traction motor with electrical power.

The vehicle systems may include vehicle auxiliary systems, such as infotainment and heating, ventilation, and air conditioning (HVAC). In such an embodiment, the vehicle immobilization mode may enable the energy storage device to supply electrical power to the vehicle auxiliary systems.

The vehicle may be a plug-in electric vehicle (PEV) having a powertrain including a traction motor, including an internal combustion engine and an automatically shiftable transmission, or a hybrid electric vehicle (HEV) including an internal combustion engine, a traction motor, and an automatically shiftable transmission.

A system for immobilizing a vehicle having a powertrain configured to provide vehicle propulsion is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a representative vehicle positioned on display and having a powertrain, an electronic controller, and a passenger cabin, according to the disclosure.

FIG. 2 is a schematic close-up view of the passenger cabin of the vehicle shown in FIG. 1 illustrating a system for immobilizing the vehicle, according to the disclosure.

FIG. 3 is a flow diagram of a method of immobilizing the vehicle shown in FIGS. 1 and 2, according to the present disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

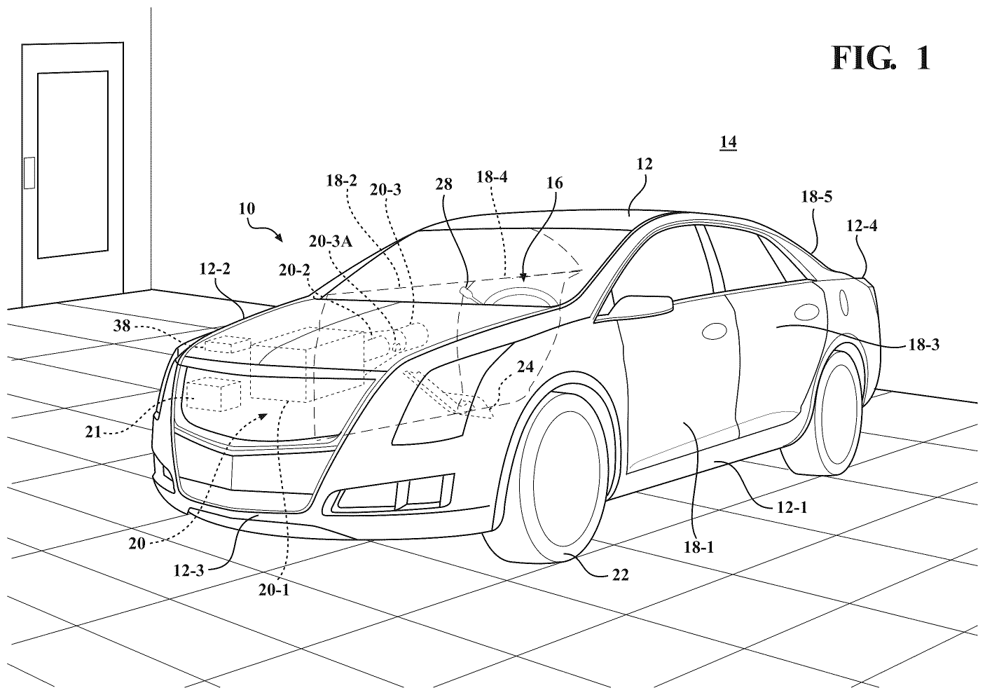

Referring to the drawings, wherein like reference numbers refer to like components throughout the several views, FIG. 1 schematically depicts a vehicle 10. The vehicle 10 is generally characterized by a vehicle body 12 surrounded by an external environment 14. The vehicle body 12 defines a vehicle interior or passenger cabin 16 configured to accommodate a vehicle operator and passenger(s), for example in a generally seated position. The vehicle body 12 includes a left-side section 12-1, a right-side section 12-2, a front-end section 12-3, and a rear-end section 12-4. The vehicle body 12 may also include a plurality of side doors, such as left-front door 18-1, right-front door 18-2, left-rear door 18-3, and right-rear door 18-4, and a tailgate 18-5 (at the rear-end section 12-4) for gaining access to the vehicle cabin 16.

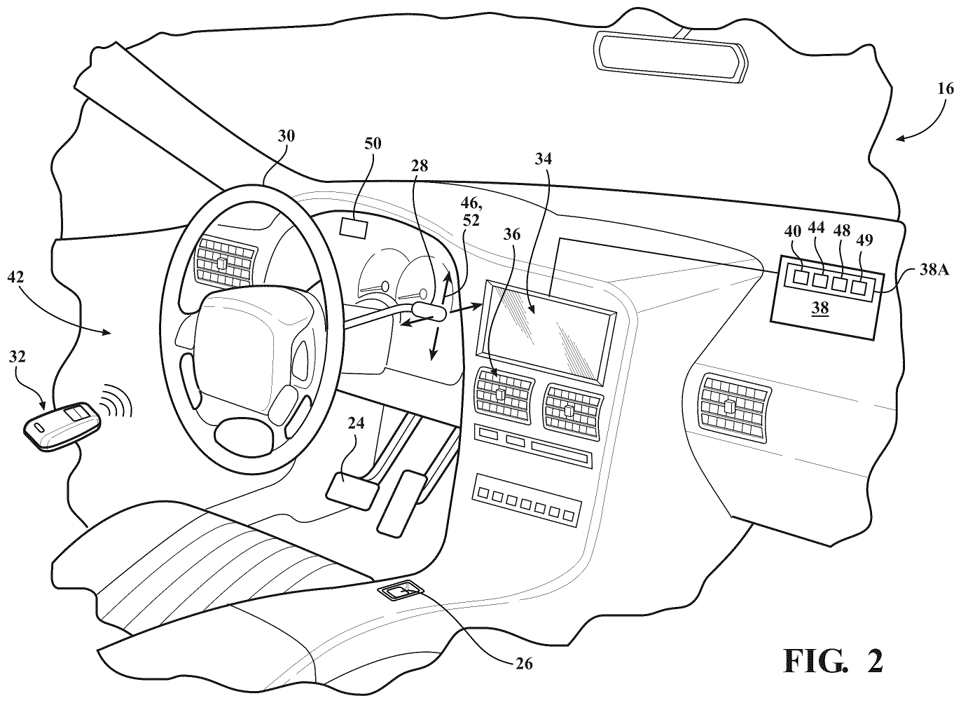

The vehicle 10 also includes a powertrain 20 configured to generate vehicle propulsion. The powertrain 20 may include an internal combustion (IC) engine 20-1, electric or traction motor(s) 20-2, and/or a fuel cell (not shown) configured to generate an output torque, and a transmission assembly 20-3, e.g., and single or multi-speed automatic transmission, to transmit powerplant torque to at least some of the road wheels 22. The vehicle 10 may therefore be configured as plug-in electric vehicle (PEV), a hybrid electric vehicle (HEV), or be conventionally powered by an IC engine. The vehicle 10 also includes an energy storage device 21, such as an electrochemical battery or a multi-cell rechargeable energy storage system (RESS) configured to supply various systems, as well as the IC engine 20-1, electric motor(s) 20-2, and/or fuel cell with electrical power. The vehicle 10 typically also includes friction brakes (not shown) arranged at the road wheels 22 and engaged by a vehicle brake actuator 24, such as a brake pedal arranged inside the vehicle cabin 16. Furthermore, the vehicle 10 typically includes a parking brake 26, which may be configured as a lever, a foot pedal, or a switch (shown in FIG. 2), for securing the vehicle in a stationary state.

As shown in FIG. 2, the vehicle 10 additionally includes a vehicle mode selector 28, such as a shift lever, configured to shift the powertrain 20 between vehicle propulsion mode, e.g., drive, individual forward gear ranges, or reverse, and vehicle park configured to block the vehicle propulsion mode and maintain the vehicle in a stationary state. Vehicle park state may be engaged via a park pawl 20-3A, controlled by the vehicle mode selector 28, in a transmission assembly 20-3. The vehicle mode selector 28 is arranged inside the vehicle cabin 16 within convenient reach of the vehicle operator, such as near a steering wheel 30. As shown in FIG. 2, the vehicle 10 further includes a vehicle key 32, such as a physical key, a smart-key (shown), or a fob transmitter. The vehicle key 32 is configured to permit the vehicle operator to activate the powertrain 20, as well as auxiliary vehicle systems, such as infotainment 34 and heating, ventilation, and air conditioning (HVAC) 36.

The vehicle 10 also includes an electronic controller 38 (shown in FIGS. 1 and 2). The electronic controller 38 may be a central processing unit (CPU) or a body control module (BCM) configured to receive data signals from various vehicle sensors and manage operation of vehicle systems. Specifically, the electronic controller 38 is in operative communication with the powertrain 20, the vehicle brake actuator 24, the parking brake 26, the vehicle mode selector 28, the vehicle key 32, and the auxiliary systems. The electronic controller 38 may be in operative communication with such vehicle systems and sensors via a data network, e.g., a Controller Area Network (CAN bus), arranged in the vehicle 10. A system 42 for immobilizing vehicle 10, shown in FIG. 2 and to be described in detail below, includes at least the powertrain 20, the energy storage device 21, the vehicle brake actuator 24, the parking brake 26, the vehicle mode selector 28, the vehicle key 32, and the electronic controller 38.

The electronic controller 38 includes a memory 38A that is tangible and non-transitory. The memory 38A may be a recordable medium that participates in providing computer-readable data or process instructions. Such a medium may take many forms, including but not limited to non-volatile media and volatile media. Non-volatile media used by the electronic controller 38 may include, for example, optical or magnetic disks and other persistent memory. Volatile media of each of the controller's memory 38A may include, for example, dynamic random-access memory (DRAM), which may constitute a main memory. Such instructions may be transmitted by one or more transmission medium, including coaxial cables, copper wire and fiber optics, including the wires that comprise a system bus coupled to the vehicle systems.

Memory 38A of the electronic controller 38 may also include a flexible disk, hard disk, magnetic tape, other magnetic medium, a CD-ROM, DVD, other optical medium, etc. The electronic controller 38 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 38 or accessible thereby, generally indicated via numeral 40, may be stored in the memory 38A and automatically executed to provide the required functionality to operate the vehicle 10 in the context of the system 42.

As part of the system 42, the electronic controller 38 is programmed to detect the vehicle systems being enabled via the vehicle key 32, e.g., via presence of the smart-key/fob inside the vehicle cabin 16. The electronic controller 38 is also programmed to detect the vehicle 10 being operated in standard production (mobilized) mode 44. In the standard production mode 44, which is typically the default factory setting of the vehicle, the vehicle mode selector 28 is enabled to shift the powertrain 20 between vehicle propulsion and the park states (wherein the park state is typically secured via the vehicle brake actuator 24 depressed or otherwise activated). The electronic controller 38 is additionally programmed to detect execution of a first predefined pattern or sequence 46 via the vehicle mode selector 28 indicative of a vehicle immobilization mode 48. The first predefined pattern 46 is intended to be implemented by the vehicle operator via the vehicle mode selector 28 with the objective to activate the vehicle immobilization mode 48.

The vehicle immobilization mode 48 is generally intended for showroom display or demonstration of the vehicle features and systems (where the external environment 14 is a dealership showroom or other controlled surroundings). In such conditions, the vehicle immobilization mode 48 enables the energy storage device 21 to provide electrical power to auxiliary systems, such as the infotainment 34, HVAC 36, power seat and window adjustments, etc. The vehicle immobilization mode 48 additionally blocks propulsion of the vehicle 10 typically enabled in standard production mode 44. The electronic controller 38 is further programmed to activate the vehicle immobilization mode 48 in response to the detected enablement of the vehicle systems via the vehicle key 32, operation of the vehicle 10 in the standard production mode 44, and execution of the first predefined pattern 46 via the vehicle mode selector 28. Specifically, vehicle immobilization mode 48 includes a vehicle park mode 49 being activated to block the vehicle propulsion mode. The vehicle immobilization mode 48 further includes the vehicle park mode 49 being maintained regardless of or despite an operator command to disengage the park mode via the vehicle mode selector 28.

The electronic controller 38 may also be programmed to trigger a sensory indicator 50, such as an audible alert and/or a visual display, indicative of the immobilization mode 48 being active. The electronic controller 38 may be additionally programmed to store the immobilization mode 48 in the controller's non-transitory memory 38A to be accessed between powertrain operation, e.g., powerplant ignition, cycles and maintain the immobilization mode following recovery from a loss of (12 Volt) electrical power to the electronic controller. The vehicle park mode 49 may include engagement of the park pawl 20-3A. The electronic controller 38 may be programmed to maintain the vehicle in park mode 49 via maintaining engagement of the park pawl 20-3A while the immobilization mode 48 is active, regardless of operator request to disengage the park pawl.

The vehicle park mode 49 may also include actuation of the parking brake 26. The electronic controller 38 may be programmed to maintain the vehicle 10 in the park mode 49 via maintaining actuation of the parking brake 26 regardless of operator request to disengage the parking brake. The electronic controller 38 may also be programmed to detect when the above-noted vehicle systems are enabled by the vehicle key 32 and detect the vehicle 10 being operated in the vehicle immobilization mode 48. A second predefined pattern or sequence 52 may be performed via the vehicle mode selector 28 to deactivate the vehicle park mode 49. Specifically, the electronic controller 38 may be programmed to detect execution of the second predefined pattern 52 indicative of deactivation or exit from the vehicle immobilization mode 48 and command deactivation of the immobilization mode. As a result, the electronic controller 38 may be configured to return the vehicle 10 to standard production mode 44 in response to the detected executed second predefined pattern 52.

Each of the first and second predefined patterns 46, 52 executed via the vehicle mode selector 28 may be a distinct sequence of positions of the vehicle mode selector or be the same sequence and pattern. Execution of each of the predefined patterns 46, 52 may be accompanied by lack of engagement of the vehicle brakes by the vehicle operator via the vehicle brake actuator 24. In other words, activation as well as the deactivation of the immobilization mode 48 may be distinguished from typical shifting between vehicle propulsion and park modes by the vehicle brakes not participating in the process of setting the vehicle up for showroom display or demonstration.

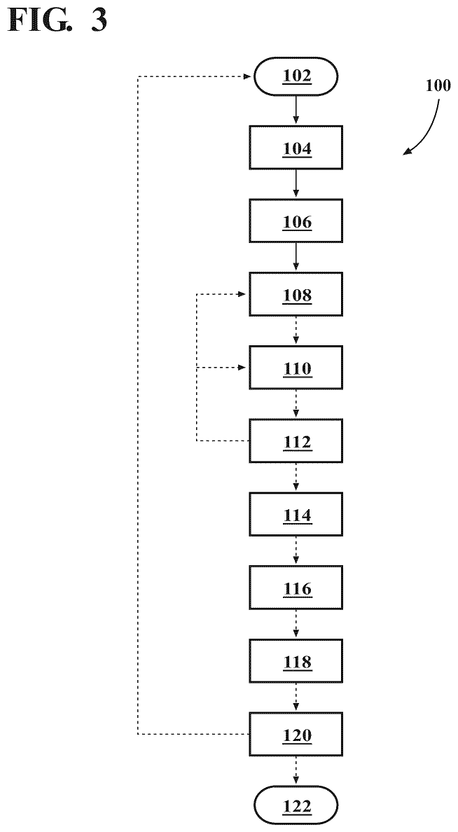

FIG. 3 depicts a method 100 of immobilizing a vehicle, such as the vehicle 10, via the system 42, as described above with respect to FIGS. 1 and 2. The method 100 is configured to facilitate showroom display or demonstration of vehicle features and systems without the risk of the vehicle 10 being inadvertently shifted into powered drive or reverse. The method 100 initiates in frame 102 with detecting, via the electronic controller 38, the vehicle systems, e.g., the infotainment 34 and HVAC 36, being enabled by the vehicle key 32. Following frame 102, the method proceeds to frame 104. In frame 104, the method includes detecting, via the electronic controller 38, operation of the vehicle 10 in the standard production mode 44 permitting the vehicle mode selector 28 to shift the powertrain 20 between vehicle propulsion and park modes.

After frame 104, the method advances to frame 106. In frame 106 the method includes detecting, via the electronic controller 38, execution of the first predefined pattern 46 via the vehicle mode selector 28 indicative of a vehicle immobilization mode 48. Following frame 106, the method proceeds to frame 108. In frame 108 the method includes activating, via the electronic controller 38, the vehicle immobilization mode 48 in response to the detected enablement of the vehicle systems via the vehicle key 32, operation of the vehicle in standard production mode 44, and execution of the first predefined pattern 46 via the vehicle mode selector 28. As described above with respect to FIGS. 1 and 2, the vehicle immobilization mode includes the vehicle park mode 49 being activated to block vehicle propulsion e.g., via the transmission park pawl 20-3A and/or the parking brake 26. The vehicle immobilization mode 48 also includes the vehicle park mode 49 being maintained regardless of an operator command to disengage the park mode.

Following frame 108, the method may proceed to frame 110. In frame 110 the method includes triggering, via the electronic controller 38, the sensory indicator 50 indicative of the immobilization mode 48 being active. After frame 110, the method may advance to frame 112 for storing, via the electronic controller 38, the immobilization mode 48 in the non-transitory memory 38A of the electronic controller. The immobilization mode 48 may be stored in the controller's memory 38A to be active between powertrain 20 operation or ignition cycles and maintaining the vehicle in the immobilization mode in the event and following recovery from loss of electrical power to the controller. Accordingly, after the powertrain 20 is turned off and restarted or after recovery from loss of electrical power the method may loop back from frame 112 to frame 108 or frame 110.

Following frame 112, the method may proceed to frame 114. In frame 114 the method includes detecting, via the electronic controller 38, the vehicle systems being enabled via the vehicle key 32. After detection of the vehicle system enablement in frame 114, the method may advance to frame 116 for detecting, via the electronic controller 38, the vehicle being operated in the vehicle immobilization mode 48. After frame 116, the method may proceed to frame 118 for detecting, via the electronic controller 38, execution of the second predefined pattern 52 via the vehicle mode selector 28. Following frame 118, the method may include commanding, in frame 120, via the electronic controller 38, deactivation of the vehicle immobilization mode 48 and a return to the standard production mode 44 in response to the detected executed second predefined pattern 52.

As noted above relative to FIGS. 1 and 2, the first and second predefined patterns 46, 52 executed via the vehicle mode selector 38 may be either distinct or identical sequences of mode selector positions. Moreover, execution of each of the predefined patterns 46, 52 to activate/deactivate the vehicle immobilization mode 48 may be accompanied by lack of engagement of vehicle brakes via the vehicle brake actuator 24. Once the vehicle 10 has been returned to the standard production mode 44 and the vehicle has been re-mobilized in frame 120, the method 100 may return to frame 102 or conclude in frame 122. Overall, method 100 permits the immobilization mode 48 to facilitate showroom display and/or demonstration of vehicle auxiliary systems, such as infotainment and HVAC without the risk of the vehicle being unintentionally put into propulsion mode.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of immobilizing a vehicle having a powertrain configured to provide vehicle propulsion, the method comprising:
detecting, via an electronic controller configured to manage operation of vehicle systems, the vehicle systems being enabled by a vehicle key;
detecting, via the electronic controller, the vehicle being operated in standard production mode, wherein a vehicle mode selector is enabled to shift the powertrain between a vehicle propulsion mode and a vehicle park mode;
detecting, via the electronic controller, execution of a first predefined pattern via the vehicle mode selector indicative of a vehicle immobilization mode;
activating, via the electronic controller, the vehicle immobilization mode in response to the detected enablement of the vehicle systems by the vehicle key, operation of the vehicle in standard production mode, and execution of the first predefined pattern via the vehicle mode selector, wherein the vehicle immobilization mode includes:
a vehicle park mode being activated to block the vehicle propulsion mode; and
the vehicle park mode being maintained regardless of an operator command to disengage the park mode.

2. The method of immobilizing a vehicle according to claim 1, further comprising triggering, via the electronic controller, a sensory indicator indicative of the immobilization mode being active.

3. The method of immobilizing a vehicle according to claim 1, further comprising storing, via the electronic controller, the immobilization mode in a memory of the electronic controller between powertrain operation cycles and maintaining the vehicle in the immobilization mode following recovery from a loss of electrical power to the electronic controller.

4. The method of immobilizing a vehicle according to claim 1, wherein the vehicle park mode includes engagement of a park pawl in an automatic transmission, and wherein maintaining the vehicle in park mode includes maintaining engagement of the park pawl regardless of a request to disengage the park pawl.

5. The method of immobilizing a vehicle according to claim 1, wherein the vehicle park mode includes actuation of a parking brake, and wherein maintaining the vehicle in the park mode includes maintaining actuation of the parking brake regardless of a request to disengage the parking brake.

6. The method of immobilizing a vehicle according to claim 1, further comprising:
detecting, via the electronic controller, the vehicle systems being enabled by the vehicle key;
detecting, via the electronic controller, the vehicle being operated in the vehicle immobilization mode,
detecting, via the electronic controller, execution of a second predefined pattern via the vehicle mode selector indicative of deactivation of the vehicle immobilization mode; and
commanding, via the electronic controller, deactivation of the vehicle immobilization mode in response to the detected execution of the second predefined pattern.

7. The method of immobilizing a vehicle according to claim 6, wherein each of the first and second predefined patterns executed via the vehicle mode selector is a distinct sequence of positions of the vehicle mode selector.

8. The method of immobilizing a vehicle according to claim 7, wherein execution of each of the predefined patterns is accompanied by lack of engagement of vehicle brakes via a vehicle brake actuator.

9. The method of immobilizing a vehicle according to claim 1, wherein the powertrain includes a traction motor and an energy storage device configured to supply the traction motor with electrical power.

10. The method of immobilizing a vehicle according to claim 9, wherein the vehicle systems include vehicle auxiliary systems, wherein the vehicle immobilization mode enables the energy storage device to supply electrical power to the vehicle auxiliary systems.

11. A system for immobilizing a vehicle having a powertrain configured to provide vehicle propulsion, the system comprising:
a vehicle key;
a vehicle mode selector configured to shift the powertrain between a vehicle propulsion mode and a vehicle park mode;
an electronic controller configured to manage operation of vehicle systems and programmed to:
detect the vehicle systems being enabled by the vehicle key;
detect the vehicle being operated in standard production mode, wherein the vehicle is enabled to be shifted out of park mode, via the vehicle mode selector, into the vehicle propulsion mode;
detect execution of a first predefined pattern via the vehicle mode selector indicative of a vehicle immobilization mode;
activate the vehicle immobilization mode in response to the detected enablement of the vehicle systems by the vehicle key, operation of the vehicle in standard production mode, and execution of the first predefined pattern via the vehicle mode selector, wherein the vehicle immobilization mode includes:
a vehicle park mode being activated to block the vehicle propulsion mode; and
the vehicle park mode being maintained regardless of an operator command to disengage the park mode.

12. The system for immobilizing a vehicle according to claim 11, wherein the electronic controller is additionally programmed to trigger a sensory indicator indicative of the immobilization mode being active.

13. The system for immobilizing a vehicle according to claim 11, wherein the electronic controller is additionally programmed to store vehicle operation in the immobilization mode in a memory of the electronic controller between ignition cycles and maintain the vehicle operation in the immobilization mode following recovery from a loss of electrical power to the electronic controller.

14. The system for immobilizing a vehicle according to claim 11, wherein the vehicle park mode includes engagement of a park pawl in an automatic transmission, and wherein the electronic controller is programmed to maintain the vehicle in park mode via maintaining engagement of the park pawl regardless of a request to disengage the park pawl.

15. The system for immobilizing a vehicle according to claim 11, wherein the vehicle park mode includes actuation of a parking brake, and wherein the electronic controller is programmed to maintain the vehicle in the park mode via maintaining actuation of the parking brake regardless of a request to disengage the parking brake.

16. The system for immobilizing a vehicle according to claim 11, wherein the electronic controller is programmed to:
detect the vehicle systems being enabled by the vehicle key;
detect the vehicle being operated in the vehicle immobilization mode, detect execution of a second predefined pattern via the vehicle mode selector indicative of deactivation of the vehicle immobilization mode; and
command deactivation of the vehicle immobilization mode in response to the detected execution of the second predefined pattern.

17. The system for immobilizing a vehicle according to claim 16, wherein each of the first and second predefined patterns executed via the vehicle mode selector is a distinct sequence of positions of the vehicle mode selector.

18. The system for immobilizing a vehicle according to claim 17, wherein execution of each of the first and second predefined patterns is accompanied by lack of engagement of vehicle brakes via a vehicle brake actuator.

19. The system for immobilizing a vehicle according to claim 11; wherein:
the powertrain includes a traction motor and an energy storage device configured to supply the traction motor with electrical power;
the vehicle systems include vehicle auxiliary systems; and
the vehicle immobilization mode enables the energy storage device to supply electrical power to the vehicle auxiliary systems.

20. A method of immobilizing a vehicle having a powertrain configured to provide vehicle propulsion, the method comprising:
detecting, via an electronic controller configured to manage operation of vehicle systems, vehicle systems being enabled by a vehicle key;
detecting, via the electronic controller, the vehicle being operated in standard production mode, wherein a vehicle mode selector is enabled to shift the powertrain between a vehicle propulsion mode and a vehicle park mode;
detecting, via the electronic controller, execution of a first predefined pattern via the vehicle mode selector indicative of a vehicle immobilization mode;
commanding, via the electronic controller, activation of the vehicle immobilization mode in response to the detected enablement of the vehicle systems by the vehicle key, operation of the vehicle in standard production mode, and execution of the first predefined pattern via the vehicle mode selector, wherein the vehicle immobilization mode includes:
a vehicle park mode being activated to block the vehicle propulsion mode; and
the vehicle park mode being maintained regardless of an operator command to disengage the park mode;
triggering, via the electronic controller, a sensory indicator indicative of the immobilization mode being active; and
storing, via the electronic controller, the immobilization mode in a memory of the electronic controller between powertrain operation cycles and maintaining the immobilization mode following recovery from a loss of electrical power to the electronic controller.
